(19) United States
(12) Patent Application Publication
(10) Pub. No.: US 2009/0106848 A1
(43) Pub. Date: Apr. 23, 2009

(54) System and method for Time Sensitive Scheduling Data privacy protection

(75) Inventor: Robert Bernard Coley, Palo Alto, CA (US)

Correspondence Address: DAVID LEWIS, 1250 AVIATION AVE., SUITE 200B, SAN JOSE, CA, 95110, US

(73) Assignee: Keep In Touch Systems, Inc.

(21) Appl. No.: 12/288,394

(22) Filed: Oct. 19, 2008

Related U.S. Application Data
(60) Provisional application No. 60/981,410, filed on Oct. 19, 2007.

(51) Int. Cl. G06F 21/00; G06F 15/16

(52) U.S. Cl. 726/26; 709/204

(57) ABSTRACT

Providing privacy protection to an entity related to the passive delivery of time sensitive scheduling data via a Time Sensitive Scheduling Data Delivery Network is described. A communications network based passive delivery of privacy protected time sensitive scheduling data is accommodated to an entity. Specific privacy protected time sensitive scheduling data from sources including originating organizations, affiliated groups of individuals, and individuals are aggregated into time sensitive scheduling data streams. Then the specific privacy protected time sensitive scheduling data streams aggregated from sources including multiple originating organizations, affiliated groups of individuals, and individuals are transmitted via the communications network to the entity. Finally the time sensitive scheduling data is presented in a manner affording privacy based on content privacy states which determine the representation of a time sensitive scheduling data item being presented.

### CROSS-REFERENCE TO RELATED APPLICATIONS

This application claims priority benefit of U.S. Provisional Patent Application No. 60/981,410, entitled, “SYSTEM AND METHOD FOR TIME SENSITIVE SCHEDULING DATA PRIVACY PROTECTION” (Docket# 102303.59569PV (P003Z)) by Robert Bernard Coley, filed Oct. 19, 2007, which is incorporated herein by reference in its entirety.

### BACKGROUND OF THE INVENTION

1. Field of the Invention

The invention relates generally to protecting the privacy of information retrieval and dissemination technologies, internet data publication techniques and targeted communications.

2. Description of the Related Art

Today many communication methods protect the privacy of a communication by either encrypting the contents or restricting access to the content. For example, content posted on a website may require a successful login to the site before protected content may be viewed. Similarly, an email message may be encrypted and a security certificate or password may be required to view its contents upon receipt. In the first case, privacy is afforded by restricting access to the contents unless a password or passkey is provided to unlock access. In the second case, all of the details of the communication exist in the packets of information being transmitted, but they are scrambled and must be unscrambled on the receiving end. In the both cases, gaining access to the communication and therefore its message is an all or nothing proposition: no encryption key or no passkey means no message from the communication is received by the viewer.

The basic problem with these approaches is that it is not always necessary or desirable to prevent access to the essence of the message when privacy is desired. Suppose, for example, that an executive wants to let her staff know via the companies shared calendar system that she will be unavailable during the afternoon due to a doctor's appointment. Our executive wants her assistant to know exactly where she is in case of an emergency, she wants her team to know that she is at a medical appointment and she only wants all other company employees to know that she will be unavailable from 2:00-5:00 PM. With current shared calendar systems, the executive can only post one message as part of her appointment notice on the system and therefore she is confronted with a dilemma: what level of information should she post on her calendar. At present, the executive can post vague notice of an appointment for all to see, and then separately send out more detailed communications to her staff and her assistant with the appropriate level of details about her appointment. This is time consuming.

### SUMMARY OF THE INVENTION

The present disclosure accommodates the protection of the privacy of a user of a Time Sensitive Scheduling Data Delivery Network.

In one embodiment of the invention, providing privacy protection to an entity related to the passive delivery of time sensitive scheduling data via a Time Sensitive Scheduling Data Delivery Network comprises accommodating a communications network based passive delivery of privacy protected time sensitive scheduling data to an entity, aggregating into time sensitive scheduling data streams, specific privacy protected time sensitive scheduling data from sources including originating organizations, affiliated groups of individuals, and individuals, transmitting via the communications network specific privacy protected time sensitive scheduling data streams aggregated from sources including multiple originating organizations, affiliated groups of individuals, and individuals to the entity, and presenting time sensitive scheduling data in a manner affording privacy based on content privacy states which determine the representation of a time sensitive scheduling data item being presented.

Another embodiment of the invention relates to transforming time sensitive scheduling data in a manner affording privacy based on content privacy states which determine the representation of a time sensitive scheduling data item being transmitted and presented.

In another embodiment of the invention, transforming consists of exposing a range of time sensitive scheduling data attributes from related attributes of identification, scheduling and location to a start date, start time and a generic icon representing a type of activity, and wherein the ranges of time sensitive scheduling data attributes exposure represent content privacy states.

In another embodiment of the invention, transforming occurs within a programming function at the sourcing data center for transmission and on capable time sensitive scheduling data receiving devices for presentation.

Another embodiment of the invention relates to establishing the content privacy state for transmission and presentation of time sensitive scheduling data according to an area of interest of the entity and reception zone for the data.

Another embodiment of the invention relates to establishing the content privacy state for transmission and presentation of time sensitive scheduling data according to affiliation between a providing entity and receiving entity.

Another embodiment of the invention relates to establishing the content privacy state for transmission and presentation of reminder time sensitive scheduling data according to an entity's presentation content privacy state preference for time sensitive scheduling data, a closeness to start time for a time sensitive scheduling data activity which is the subject of the reminder time sensitive scheduling data, and a device receiving the reminder time sensitive scheduling data.

In another embodiment of the invention, the reminder time sensitive scheduling data comprises time sensitive scheduling data items selected from the group consisting of receiving entity designated reminder items, receiving entity tagged reminder item, time sensitive scheduling data delivery network treated major life event items, and a combination thereof.

Another embodiment of the invention relates to establishing the content privacy state for transmission and presentation of reservation time sensitive scheduling data according to an entity's presentation content privacy state preference for time sensitive scheduling data, a closeness to start time for a time sensitive scheduling data which is the subject of the reservation time sensitive scheduling data time sensitive scheduling data, and a device receiving the reservation time sensitive scheduling data.

In another embodiment of the invention, the privacy afforded is based on the representation of a time sensitive scheduling data item within a communication transmitted from a data center source data store to a receiving device.

In another embodiment of the invention, the representation of time sensitive scheduling data items transmitted range from sending identification and scheduling details of the item from the item attributes including name, start and end date, start and end time, location and activity description to sending an encoded string of characters which when decoded by a receiving device reproduces the item attributes and representation of item attributes from the group of item attributes including name, start date, start time, and location.

In another embodiment of the invention, the representation of a time sensitive scheduling data item ranges from presenting identification and scheduling details of the item from the item attributes including name, start and end date, start and end time, location and activity description to presenting a blocked out area indicating start time and end time of an unidentified time sensitive data item.

Another embodiment of the invention relates to protecting the privacy of a time sensitive scheduling data delivery network user by providing a designated and desired level of privacy in accordance with a time sensitive scheduling data receiving device's profile and assigned privacy preference.

In another embodiment, a system for providing privacy protection to an entity related to the passive delivery of time sensitive scheduling data via a Time Sensitive Scheduling Data Delivery Network is described. The system may include a time sensitive scheduling data center for storing privacy protected time sensitive scheduling data, collecting privacy protected time sensitive scheduling data from an entity, and sending privacy protected time sensitive scheduling data to the entity, connectivity medium communication interfaces for transmitting privacy protected time sensitive scheduling data between the time sensitive scheduling data center, a communication technology, and a time sensitive scheduling data receiving device, and a a communication technology suitable for receiving and sending the passive delivery of privacy protected time sensitive scheduling data. The system may also include processors for processing executable instructions for accommodating a communications network based passive delivery of privacy protected time sensitive scheduling data to an entity, aggregating into time sensitive scheduling data streams, specific privacy protected time sensitive scheduling data from sources including originating organizations, affiliated groups of individuals, and individuals, transmitting via the communications network specific privacy protected time sensitive scheduling data streams aggregated from sources including multiple originating organizations, affiliated groups of individuals, and individuals to the entity, and presenting time sensitive scheduling data in a manner affording privacy based on content privacy states which determine representation of a time sensitive scheduling data item being presented. Finally, the system may also include a time sensitive scheduling data receiving device for receiving and sending protected privacy time sensitive scheduling data to the time sensitive scheduling data center via the connectivity medium communication interfaces via the communication technology.

Another embodiment provides a computer program product executable by a computer processor for processing the providing privacy protection to an entity related to the passive delivery of time sensitive scheduling data via a Time Sensitive Scheduling Data Delivery Network. The computer program product may include computer code for accommodating a communications network based passive delivery of privacy protected time sensitive scheduling data to an entity, computer code for aggregating into time sensitive scheduling data streams, specific privacy protected time sensitive scheduling data from originating organizations, affiliated groups of individuals, and individual sources, computer code for transmitting via the communications network specific privacy protected time sensitive scheduling data streams aggregated from multiple originating organizations, affiliated groups of individuals, and individual sources to the entity, computer code for presenting time sensitive scheduling data in a manner affording privacy based on content privacy states which determine the representation of a time sensitive scheduling data item being presented, and computer readable medium for storing the computer code.

### BRIEF DESCRIPTION OF THE DRAWINGS

Detailed and specific features of the present invention are more fully disclosed in the following sections, with reference being made to the accompanying drawings, in which:

FIG. 1 is a simplified system diagram of a Time Sensitive Scheduling Data Delivery Network according to one embodiment of the invention;

FIG. 2 is a representation of an activity and promotional content delivery communications system showing the location of the Privacy Protection Functions in a Time Sensitive Scheduling Data Delivery Network according to one embodiment of the invention;

FIG. 3 is a flowchart of a time sensitive scheduling data fulfillment process showing the location of the Privacy Protection Functions according to one embodiment of the invention;

FIG. 4 is a class diagram displaying Time Sensitive Scheduling Data Content Privacy States according to one embodiment of the invention;

FIGS. 5a-5h are representations of a time sensitive scheduling data activity displayed in various privacy protection modes according to one embodiment of the invention;

FIG. 6 is a flowchart showing two methods a user may use to specify a desired level of privacy protection for displaying time sensitive scheduling data according to one embodiment of the invention;

FIG. 7 is a class diagram illustrating time sensitive scheduling data providers of time sensitive scheduling data according to an embodiment of the invention;

FIG. 8 is a class diagram illustrating target audiences according to an embodiment of the invention; and

FIG. 9 is an objects diagram illustrating basic attributes of time sensitive scheduling data according to an embodiment of the invention.

### DETAILED DESCRIPTION OF THE INVENTION

Reference throughout this specification to “one embodiment” or “an embodiment” means that a particular feature, structure, or characteristic described in connection with the embodiment may be included in at least one embodiment of the present invention. Thus, the appearance of the phrase “in one embodiment” or “an embodiment” in various places throughout this specification does not necessarily refer to the same embodiment. Furthermore, the particular features, structures, or characteristics may be combined in one or more embodiments.

In the following description, for purposes of explanation, numerous details are set forth, such as flow charts and system configurations, in order to provide an understanding of one of more embodiments of the present invention. However, it is and will be apparent to one skilled in the art that these specific details are not required in order to practice the invention.

Accordingly, what is needed is a more flexible and efficient approach in which varying degrees of a messaging may be exposed based on the level of privilege the receiver is granted from a single communication or notice.

In one embodiment of the systems and methods disclosed herein, the components are a type of activity data referred to as time sensitive scheduling data (TSSD) described herein, a set of functions which may encompass the collection, storage, maintenance and orderly dissemination of TSSD, a set of functions which apply privacy protection methods to the TSSD, hardware and software which perform these functions and entities which produce and consume TSSD.

### DEFINITIONS

As used in this description and the accompanying claims, the following terms shall have the meanings indicated, unless the context otherwise requires:

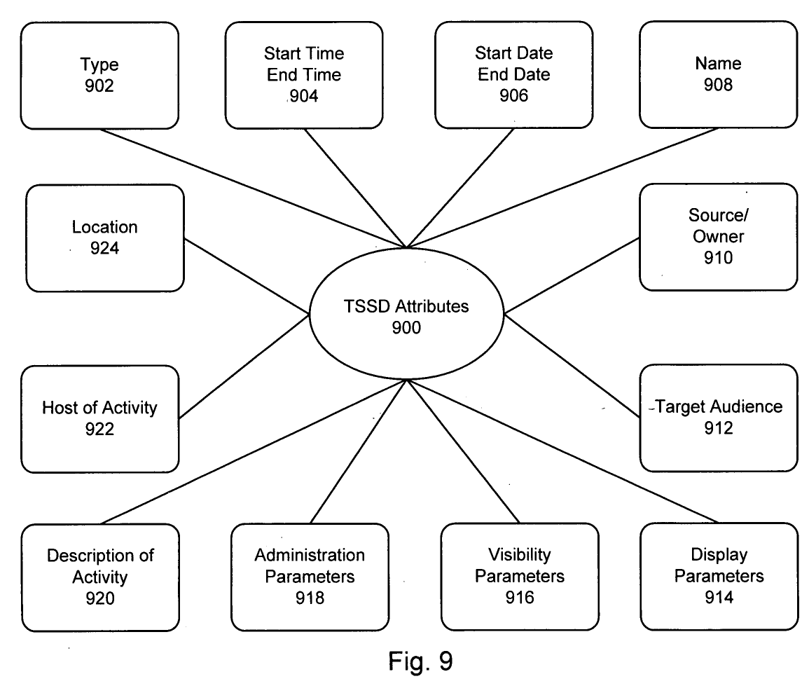

“Time sensitive scheduling data (TSSD)” refers to data relating to the class of entity activities including attending, timely participating, scheduling, planning, organizing, responding and reserving. The TSSD originates from the class of TSSD activity sources including standard events, standard meetings, ad hoc activities, and observances. This TSSD data has high utility and is frequently referenced in its relationship to an individual's continually changing activities. Also such data is not of transitory interest to users, since checking one's schedule is a necessary activity that an individual does numerous times on a daily basis. An objects diagram in FIG. 9 illustrates the basic attributes for TSSD.

“Channel” may refer to a data stream containing one or more “profiled” (selected based on specific criteria which may include affiliation, derived interests, time frame, geographic basis of source and type of TSSD) and prioritized feed packets of content.

“Cloud” may refer to homogeneous groups of cooperating networks which deliver data from a source to a destination via one or more paths that may generally be determined by the cooperating networks components, and not by the originating source device or the destination receiving device. It should be appreciated that the path by which the data reaches the source may be unpredictable or unidentifiable in advance.

“Entity” may refer to consuming entities whose actions consume time sensitive scheduling data, producing entities whose activities produce time sensitive scheduling data, providing entities who submit time sensitive scheduling data intended for consumption by other entities, and receiving entities who control what is received and presented on the time sensitive scheduling data receiving device used for consumption of time sensitive scheduling data by entities. The consuming entities may include individual members or affiliates of time sensitive scheduling data delivery network client organizations, interested individuals who browse time sensitive scheduling data network communications site, time sensitive scheduling data delivery network subscribers, members or affiliates of entities displaying time sensitive scheduling data activity feeds, and individuals passing by areas display time sensitive scheduling data activity feeds. The producing entities may include individuals, members of formal organizations, staffs of formal organizations, affiliated groups of individuals, viewers from non-affiliated groups, individuals in common interest groups, and individuals in a common space at the same time. Both the providing entities and receiving entities may include individuals, members of formal organizations, staffs of formal organizations, members of affiliated groups of individuals in non-formal organizations, and individuals in common interest groups.

“Connectivity medium” means a medium (e.g., air, wire, or fiber) between two or more nodes that provides a communication network with a channel. In the present disclosure, the connectivity medium may function as a channel that communicates the required request, credentials, and keys that allow for the movement of TSSD.

“Distribute TSSD” may refer to the streaming of TSSD data to TSSD receiving devices when a specific profile match or a specific affiliation match is present or the receiving entity is known to the TSSD provider.

“Disseminate TSSD” may refer to the streaming of TSSD data to TSSD receiving devices when a specific profile match or a specific affiliation match may not be present or the receiving entity is unknown to the TSSD provider.

“Feed” may refer to a data stream containing one or more specific categories of content. Individual units of content may be designated as feed packets or payloads. Each feed may comprise a set of rules for pulling TSSD out of the data store.

“Need to Know data” may refer to data pertaining to activities or events which impact the health and safety of an individual, a community's members, an individual's relations or a specific group of individuals. Need to know time sensitive scheduling data may include activities which are generally non-routine, unscheduled or unplanned activities. Need to know time sensitive scheduling data may include data such as the occurrence of a natural disaster and its related recovery activities: opening of shelters, delivery schedule of food, water and supplies, and opening of relief services offices. Other examples may include road opening and closing schedules, school or public service office opening and closing schedules.

“Network” may refer to groups of computers, terminals, phones, cameras, and linking communications devices which may include routers, switches, hubs, antennas, and relays linked by wired or wire-less telecommunications systems for the purpose of exchanging data. Network, as used herein, may generally refer to a group of devices working together for a specific purpose involving the exchange of data.

“Reception Zone” may refer to geographic and physical location of the where the received type sensitive data is presented, such as in a company lobby, on an office desktop, or at home in private. Reception Zone may also refer to the receiving device type such as a cell phone, a billboard, a public kiosk, and a home TV.

“Server” may refer to any combination of computer hardware or dedicated computing device(s) and software which has as one of its functions the collection, storing, aggregation, packaging and/or dissemination of a specific class of data upon request. In one embodiment, a combination which comprises a server may be based on the homogenous data or data formats that are extracted from storage, manipulated if necessary by some set of rules or policies, and “served up” upon request from one or more entities or functions which consume the data to perform its processes. A single computer may host (provide) several server functions and a single server function may be hosted (shared/provided) by more than one computer or dedicated computing device.

An “activity acquisition” server is a server which functions to harvest, aggregate and/or manipulate TSSD activity data.

An “organization-managed” activity acquisition server is an activity acquisition server where the activity data harvested by such server may have been created and maintained on the server by any or all members of the organization providing the activity data and the organization takes responsibility for the content of the activity data (e.g., activity name, description, activity date, activity time, activity location, attendee policy and fees).

An “individual-managed” activity acquisition server is an activity acquisition server where the activity data harvested by such server is either 1) is the activities of others, i.e., not originated by the individual, but is recorded and maintained on the server by the individual providing the activity data or 2) is the personal activities of individual and the individual takes responsibility for the content of the activity data (e.g., activity name, description, activity date, activity time, activity location, attendee policy and fees).

A “foreign activity acquisition server” is an activity acquisition server where the activity data harvested by such server is the activities not of the providing organization, but of others, i.e., not originated by the organization providing the data. The activity data may be recorded, but not maintained on the server by the organization providing the activity data.

“Site” means a reception zone for the receipt of TSSD that is cross-platform and cross-technology (e.g. web, handheld mobile devices, TV, kiosks, cellular phones, and other similar devices).

“Transmit” means to transfer data from one device to another device via one or more communications protocols, one or more communications media and one or more communication applications which facilitate the transfer of data across communications media by implementing one or more communications protocols. In an embodiment of the invention, TSSD and related collateral data can be transmitted via email, http protocol to a host browser over the Internet, via cellular or other telephony text messaging systems, via voice over a telephony network, over broadcast systems for radio, TV, cable and satellite and over evolving systems for extending the internet: Wi-Fi networks, public utility electrical systems, fiber optic communications systems, microwave communications, photoelectric communication system and wired local area networks.

In one embodiment of the invention, the privacy afforded to a message within a communication may be based on the level of detail about an activity within the communication which is displayed or played. The activity details exposed range from displaying primary details of an activity such as name, date, time, time zone, location and activity description to merely displaying an icon representing the type of the activity along with a date, and time. In another embodiment, the privacy afforded to a message within a communication may be based on the level of detail transmitted from the source data store to the receiving device. The activity details transmitted range from sending primary details of the activity such as name, date, time, time zone, location and activity description to sending date, time and a token indicating that an area of a calendar should be marked as reserved or unavailable. At the lowest level of privacy, any one observing the display of the activity would understand its meaning: where and when to participate, what the activity entails and to whom the activity was targeted. At the highest level of privacy, only the user or someone well informed about the context of the activity would be able to supply the additional context information to identify the exact activity represented by the communication. For example, at the lowest level of privacy, an activity might be displayed as “Dr. Smith Clinic Visit, 123 Main Street, Anytown, NY, 8:30 AM-10:00 AM, annual physical and consultation (bring list of medications). At the highest level of privacy the same activity might appear as a box labeled “unavailable 8:30 AM-10:00 AM.”

Another embodiment of the invention relates to protecting the privacy of a user of the Time Sensitive Scheduling Data Network by displaying or playing requested time sensitive scheduling data in a manner which expresses the users desired level of exposure of the details related to time sensitive scheduling data such as an event, meeting, appointment or social activity.

In another embodiment of the invention, displaying time sensitive scheduling data in a manner which conveys the essence of an activity sufficient for the user to make scheduling decisions comprises making decisions about attendance and participation in an activity, becoming informed of upcoming observances, and providing a time sensitive scheduling data delivery network user a designated and desired level of privacy for the time sensitive scheduling data displayed.

In one embodiment of the invention, protecting the privacy of a user of the Time Sensitive Scheduling Data Network comprises transmitting requested time sensitive scheduling data via the communications network in a manner which expresses the users desired level of exposure of the details related to time sensitive scheduling data such as an event, meeting, appointment or social activity.

In another embodiment of the invention, transmitting time sensitive scheduling data via the communications network in a manner which conveys the essence of an activity sufficient for the user to make scheduling decisions comprises making decisions about attendance and participation in an activity, becoming informed of upcoming observances, and providing a time sensitive scheduling data delivery network user a designated and desired level of privacy for the time sensitive scheduling data displayed.

In another embodiment of the invention, the user may designate a level of privacy for the display or transmission of the user's requested time sensitive scheduling data which allows the user to dynamically control how much content appears representing the time sensitive scheduling data.

In another embodiment of the invention, the Time Sensitive Scheduling Data Network may simultaneously support different levels of transmission or display privacy for the same activity being displayed on different time sensitive data receiving devices.

In another embodiment of the invention, relevant and desired time sensitive scheduling data are delivered in a protected privacy mode to the entity wherever the entity may be.

In one embodiment of the invention, communications network delivery of privacy protected time sensitive scheduling data to an entity comprises sending and receiving via a communications network specific time sensitive scheduling data from originating organizations, affiliated groups of individuals, and individual sources, transmitting via the communications network specific time sensitive scheduling data streams aggregated from multiple originating organizations, affiliated groups of individuals, and individual sources to the entity based on desirability and relevancy of high utility time sensitive scheduling data, and accommodating the delivery of time sensitive scheduling data to the entity via a time sensitive scheduling data receiving method based upon interests of the entity.

In another embodiment of the invention, the specific privacy protected time sensitive scheduling data sent and received is related to activities of at least one of originating organizations, affiliated groups of individuals, and individual sources.

In another embodiment of the invention, the specific privacy protected time sensitive scheduling data are transmitted as an individual item and in bulk.

In another embodiment of the invention, streaming filtered, privacy protected time sensitive scheduling data that fall into a specific category of time sensitive scheduling data and area of interest of the entity are transmitted.

In another embodiment of the invention, accommodating the targeted delivery of privacy protected time sensitive scheduling data is to a display device at a location where viewers matching a specific profile are trafficking.

In another embodiment of the invention, accommodating the delivery of privacy protected time sensitive scheduling data is to a communications display in response to an occurrence of a specific event.

In another embodiment of the invention, accommodating the delivery of privacy protected time sensitive scheduling data is to an audio device in response to an occurrence of a specific event.

In another embodiment of the invention, accommodating the delivery of privacy protected time sensitive scheduling data comprises establishing the privacy level for transmission or display of time sensitive scheduling data according to the area of interest of the entity.

In another embodiment of the invention, accommodating the delivery of privacy protected time sensitive scheduling data comprises establishing the privacy level for transmission or display of time sensitive scheduling data according to affiliation between entities.

In another embodiment of the invention, accommodating the delivery of privacy protected time sensitive scheduling data comprises establishing the privacy level for transmission or display of reminder time sensitive scheduling data according to an entity's display privacy mode preference for time sensitive scheduling data, the closeness to start time for the time sensitive scheduling data activity which is the subject of the reminder request, or the device receiving the time sensitive scheduling data activity which is the subject of the reminder request.

In another embodiment of the invention, accommodating the delivery of privacy protected time sensitive scheduling data comprises establishing the privacy mode for transmission or display of reservation time sensitive scheduling data according to an entity's display privacy mode preference for time sensitive scheduling data, the closeness to start time for the reservation, or the device receiving the reservation time sensitive scheduling data.

In another embodiment of the invention, accommodating the delivery of time sensitive scheduling data comprises establishing the privacy mode for transmission or display according to an entity's need to know.

In another embodiment of the invention, accommodating the delivery of time sensitive scheduling data comprises establishing the privacy mode for transmission or display according to an entity's affinities.

In another embodiment of the invention, communications network based delivery of time sensitive scheduling data to an entity further comprises distributing and disseminating time sensitive scheduling data which automatically provides targeted entities with time sensitive scheduling data of personal interest to facilitate timely attendance and participation in a designated area of interest of the entity.

In another embodiment of the invention, the time sensitive scheduling data as described above consists of data relating to the class of entity activities selected from the group consisting of attending, timely participating, scheduling, planning, organizing, timely responding, reserving, and a combination thereof. The class of entity activities originates from the class of time sensitive scheduling data activity sources selected from the group consisting of standard events, standard meetings, ad hoc activities, observances, and a combination thereof.

In another embodiment of the invention, the passive delivery of the time sensitive scheduling data to the entity as described above may include the entity not having identified in advance the specific time sensitive scheduling data items delivered, not having requested the specific time sensitive scheduling data items which are transmitted based on a receiving device and consumer profile, and not having any content control of the specific time sensitive scheduling data items which have been delivered in advance of the time sensitive scheduling data items presentation.

In another embodiment of the invention, the passive delivery of the time sensitive scheduling data to the entity as described above may include the entity yielding control over the specific time sensitive scheduling data items selected for delivery, yielding control over the volume of time sensitive scheduling data items delivered, yielding control over how much information is delivered about the specific time sensitive scheduling data items, and yielding control over delivery time.

In another embodiment of the invention, the passive delivery of the time sensitive scheduling data to the entity as described above may include time sensitive scheduling data items selected for delivery based on the entity's derived interest and need to know related to the public health and safety of the entity and entity's current condition and state being impacted by the public health and safety issue.

In another embodiment of the invention, the time sensitive scheduling data items delivered as described above are selected from the group consisting of being known or unknown to a consuming entity in advance of their presentation, being not provided by the consuming entity, being targeted directly or indirectly at the consuming entity as a member of a class possessing specific attributes by the providing entities, belonging to a time sensitive scheduling data channel which has been subscribed to by the consuming entity, belonging to a time sensitive scheduling data channel which has been assigned to the consuming entity, pertaining to the time frame being presented by the time sensitive scheduling data receiving device, and a combination thereof.

Another embodiment of the invention relates to extracting time sensitive scheduling data from time sensitive scheduling data delivery network data center stores based on fulfillment requests consisting of fulfillment request from the group including time sensitive scheduling data provider targeting requests, requests derived from subscriber profiles, requests derived from time sensitive scheduling data receiving device's profile, requests based on the consumer user's affiliations and affinities, and specific requests from an entity using a time sensitive scheduling data receiving device.

The TSSD privacy protection method described herein may include portable display time sensitive scheduling data receiving devices selected from the group comprising mobile computing devices, personal digital assistants (PDAs), cellular phones, personal computers, portable workstations, and a combination thereof.

The TSSD privacy protection method may include fixed placement display time sensitive scheduling data receiving devices in display locations selected from the group comprising public place business display screens, home entertainment appliance display screens, business display screens in a public place, business display screens on company property in public areas, business display screens on company property in private areas, and a combination thereof.

The TSSD protection privacy method may also include linked devices in the fixed placement display time sensitive scheduling data receiving device selected from the group comprising computers that run a single function TSSD privacy protection method access software product, computers that run browsers linked into a time sensitive scheduling data display website, computers that run a time sensitive scheduling data tuner and display software, set top tuners for home entertainment appliances, stand alone tuners with web access, and a combination thereof.

The present invention can be implemented in various different forms, including but not limited to: business processes, computer implemented methods, computer program products, computer systems, and communication networks, user interfaces, application programming interfaces, and the like.

The communications network may include simple devices, advanced devices, individual access devices, and community access devices.

The simple device may be a low-end price competitive device that receives TSSD. It may be able to send a Yes/No indicator in response to something on the device screen. The simple device may also receive TSSD based on who the user is and/or what the interest profile is of the user.

The aforementioned advanced device may have all the capabilities of the simple device plus some additional communications capabilities. By way of example, such a device may have a full two-way interactive device. Some of its features may include a larger screen and easy manipulation of on-screen information. The advanced device may come in various sizes and shapes and changes where people may go to get critical information at several points during their day. The embedded systems devices may include cellular phones, PDAs, mobile digital assistants with cellular phones, text messaging devices and PDAs and Java (MIDP-mobile information device profile) enabled devices, multifunction wristwatches, and handheld computing devices.

The individual access devices such as the laptop computer, desk top computer, cellular phone, and PDA may allow a single user to receive TSSD into a reception zone, often in a web browser format. These individual access devices typically already have web browser capability built-in. One of the access devices in this category is a web browser with a special web interface that is designed to receive TSSD. This mimics the advanced device functions somewhat, except as a web application. Another access device is a cellular phone using the web interface that is now available in many mid-to-high end cellular phones. Another access device is a PDA using the internet interface that is available now in cellular or Wi-Fi connected PDA devices. Other embedded systems devices can use non-web integration.

The community access devices may allow multiple users to receive TSSD into a reception zone, often in a web browser type format. One of the access devices in this category may be a set top box, for example. The set top box may use the web interface and keyboards that are available with some set top box vendors. This is typically the in-home TV access to TSSD. Another reception zone is a kiosk. This is typically activity data shown in a communal or public area. Vertical kiosk applications come out of this area with payment structures such as from a sponsor paying to the public user paying. In some parts of the world, this is a substitute for a local or regional newspaper or a way to check on government services without a long wait in lines. A third community reception zone is a broadcast channel which may allow the user to receive TSSD into a reception zone on a broadcast media channel the user is watching. These are zones of traveling message data strips on cable channels or more standalone captive areas like airport system screens. The scrolling TSSD seen there is based on location and the business function at that location. The media types for these streams are varied and include internet protocol, telephony, and both on-air cable and private cable.

In a pure push system, content may be streamed to a user as determined by the provider. The user has the option of consuming (i.e., viewing, listening, or feeling) the content or ignoring the content. In one modified push system, the user may have the option to block (filter) unwanted content and the provider cannot override the consumer's choice not to receive specific types of content.

In a pure pull system, a user requests specific available content and the content is streamed to the user's receiving device for consuming (i.e., viewing, listening, or feeling). In one modified pull system, the user may request a category of content or specific content, but the provider has the option to target specific consumers and thereby filter what is streamed to a user. The user cannot override the provider's choice not to stream content to the specific user.

In the TSSD privacy protection method, the types of data collected from providers may include meeting information, event information, and volunteer opportunity information. Based on this type of collected data, the TSSD privacy protection can be implemented in a manner which shields activity details from viewers or listeners according to the wishes of the originator, owner, system administrator or user requesting the activity data.

In an embodiment of the invention, private TSSD is activity content provided by the ultimate consumer of the TSSD for that consumer's private use. There may not be an intent for this information to be shared with other entities with the possible exception of family members, i.e., pushed on TSSD channels. When a user is streamed their private TSSD, no filtering need be applied.

In an embodiment of the invention, public TSSD may be activity content provided with the intent of this content being consumed (i.e., viewed, heard, or felt) by affiliated or subscribed entities. The intent may be to inform others by providing this content for distribution to affiliated entities.

In an embodiment of the invention, a privacy circle may be a set of one or more entities designated by a private TSSD provider to be treated as a proxy or the same as the entity providing the private TSSD content. Thus, entities of a privacy circle inherit the same attributes and a status as the TSSD provider with regards to the specific channel in which that private TSSD is streaming.

According to another embodiment, the TSSD fulfillment process may involve both a modified push system in which content is sent to the user, and a modified pull system in which the user requests the content details or opens a gateway to new TSSD content. At any given moment a user may be receiving pushed content from one or more channels streams based on the list of channels which the user has authorized, i.e., chosen to monitor. In addition, the same user may be receiving pushed content which is sponsoring the chosen channel or content which is targeted at the channel.

In the TSSD fulfillment process, the type of data collected from providers and streamed to consumers may be public or private. In the modified push system, the public TSSD content comes filtered by, for example, TSSD profile category, region purchased and jurisdiction purchased. The private data is streamed unfiltered, but targeted only to the user or their designated privacy circle. In the modified pull system, the requested private TSSD content detail is returned to its user or their designated privacy circle, but is blocked from streaming to any other requesting entity. In the modified pull system the requested public TSSD content detail is returned if the requestor's profile or affiliation meets the targeting criteria of the public TSSD content provider.

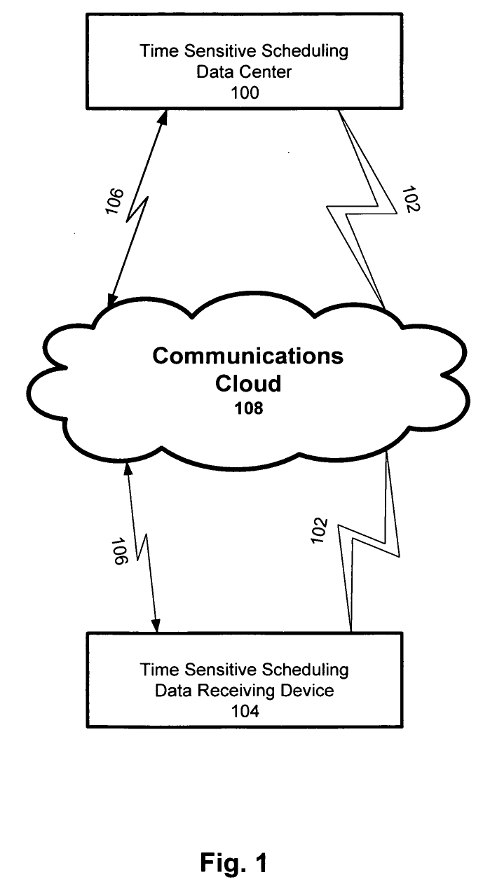

FIG. 1 is a simplified schematic of a communications network configured in accordance with the principles of one embodiment of the invention. In the embodiment of FIG. 1, a TSSD center 100 can collect and store TSSD via a connectivity medium 102. A TSSD receiving device 104 may then transmit authentication information to the TSSD center 100, via a connectivity medium 106, to a communications cloud 108. The authentication information may contain a subscription fulfillment request, and credentials which include location information (Internet Protocol (IP) address, media access control (MAC) address, mobile identification number (MIN), electronic serial number (ESN), Box ID, subscription channel ID, subscriber ID, or similar ID uniquely identifying the TSSD receiving device 104), and authorization and decoding encryption keys.

The TSSD center 100 may then validate the user's subscription fulfillment request and credentials received from the communications cloud 108 via the connectivity medium 106. If the credentials are valid, the TSSD via the connectivity medium 102 may be returned to the TSSD receiving device 104 through the communications cloud 108. If the credentials are invalid, a rejection message may be transmitted to the TSSD receiving device 104, via the connectivity medium 106, through the communications cloud 108. The TSSD center 100 streams the TSSD via the connectivity medium 102 related to an organization's, association's, and individual's events, activities, and meetings.

It should be appreciated that the receiving device 104 may include a PDA, cellular phone, or personal computer, or other similar device. These portable display TSSD receiving devices may connect to the TSSD center 100 via communication cloud 108, which may include wireless fidelity (Wi-Fi) link, cellular phone service, local access network (LAN), broadband link, or other similar methods, and an Internet service provider's (ISP) services. The method of communication may include an Internet access method and web browser or a cellular data transfer method.

The receiving device 104 may further include fixed placement display devices. The fixed placement display TSSD receiving devices may provide display locations which can include public place display screens, home entertainment appliance display screens, business display screens in a public place, business display screens on company property in public areas such as a lobby, or business display screens on company property in private areas such as an office or factory floor. The fixed placement display TSSD receiving devices may contain computer access devices and similar devices (software and hardware) which display user functions available to the viewer, carry out communications functions, transmit and receive requests for authorization and TSSD and display messages or results of the requests. The computer access devices in the fixed placement display TSSD receiving devices may include computers that run the single function access software, computers that run browsers linked into a TSSD display website, computers that run a TSSD tuner and display software, set top tuners for home entertainment appliances, stand alone tuners with web access, or other similar devices. The fixed placement display TSSD receiving devices may link to the TSSD center 100 via communication cloud 108 which can include Wi-Fi link, cellular phone service, phone dial-up, radio frequency (RF), LAN, broadband link, satellite, or similar methods. The method of communication may include an Internet access method and web browser, a broadcast data transfer method, a cable media data transfer method or a cellular data transfer method,

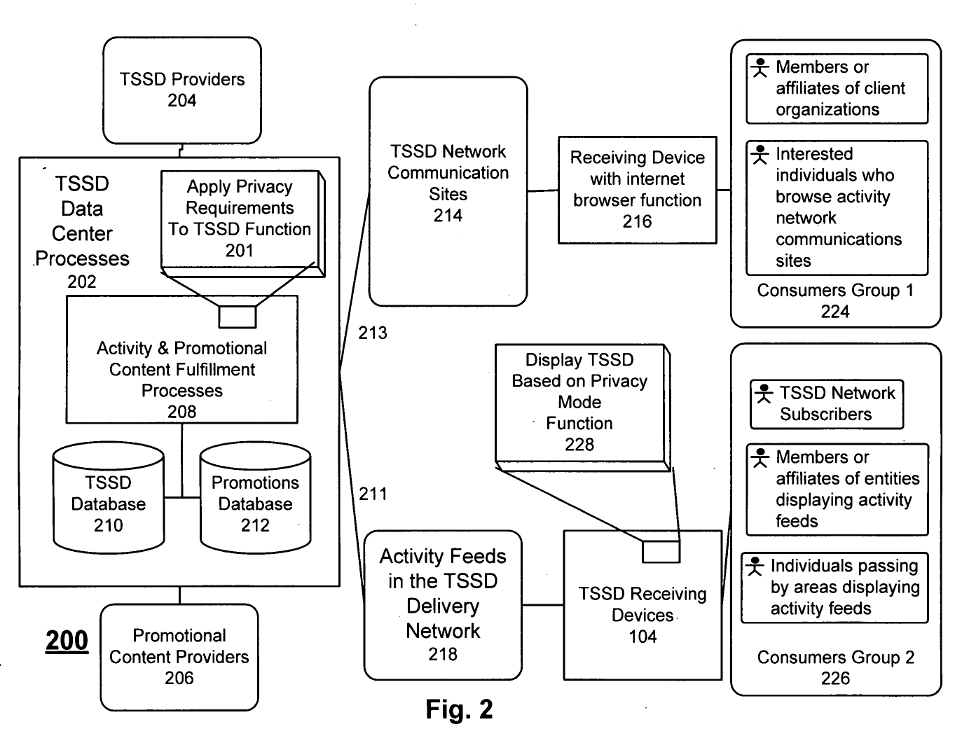

FIG. 2 is a representation of one embodiment of an activity and promotional content delivery communications system 200 showing the location of the Privacy Protection Functions in a TSSD Delivery Network. In this embodiment, activity content from TSSD Providers 204 is maintained in the TSSD Database 210 and promotional content from Promotional Content Providers 206 is maintained in the Promotions Database 212 by TSSD Data Center Processes 202. When users in Consumers Group 1 224 and Consumers Group 2 226 initiate sessions via receiving devices, which may include receiving devices with internet browser functions 216 and TSSD Receiving Devices 104, the Activity & Promotion Content Fulfillment Processes 208 extract and transmit on line 213 activity and promotional content which will appear on TSSD Network Communications Sites 214 and on line 211 embedded in Activity Feeds in the TSSD Delivery Network 218. In this embodiment of the invention, TSSD may be targeted at Consumers Group 1 224: members or affiliates of client organizations and interested individuals who because of their affiliation browse the activity network communications sites such as the TSSD Network Communication Sites 214. Privacy protected TSSD arrives and is displayed on receiving devices with internet browsers functions 216 based on the Activity and Promotion Content Fulfillment Processes 208 having applied a function to Apply Privacy Requirements to TSSD Function 201 before transmission on line 213. TSSD may be targeted at Consumers Group 2 226: TSSD network subscribers, members or affiliates of entities displaying activity feeds and individuals who pass by or through an area displaying activity feeds who because of their affiliation, affinity or interest view the activity content on TSSD Receiving Devices 104. TSSD Receiving Devices 104 include internet browser enabled and non-internet browser enabled devices. Privacy protected TSSD arrives and is displayed on TSSD Receiving Devices 220 with internet browsers functionality based on the Activity and Promotion Content Fulfillment Processes 208 having applied a function to Apply Privacy Requirements to TSSD Function 201 before transmission on line 211. On non-internet browser enabled TSSD Receiving Devices 104, TSSD content may arrive unprotected and be converted to privacy protected TSSD prior to displaying the content by an embedded display TSSD Based on Privacy Mode Function 228.

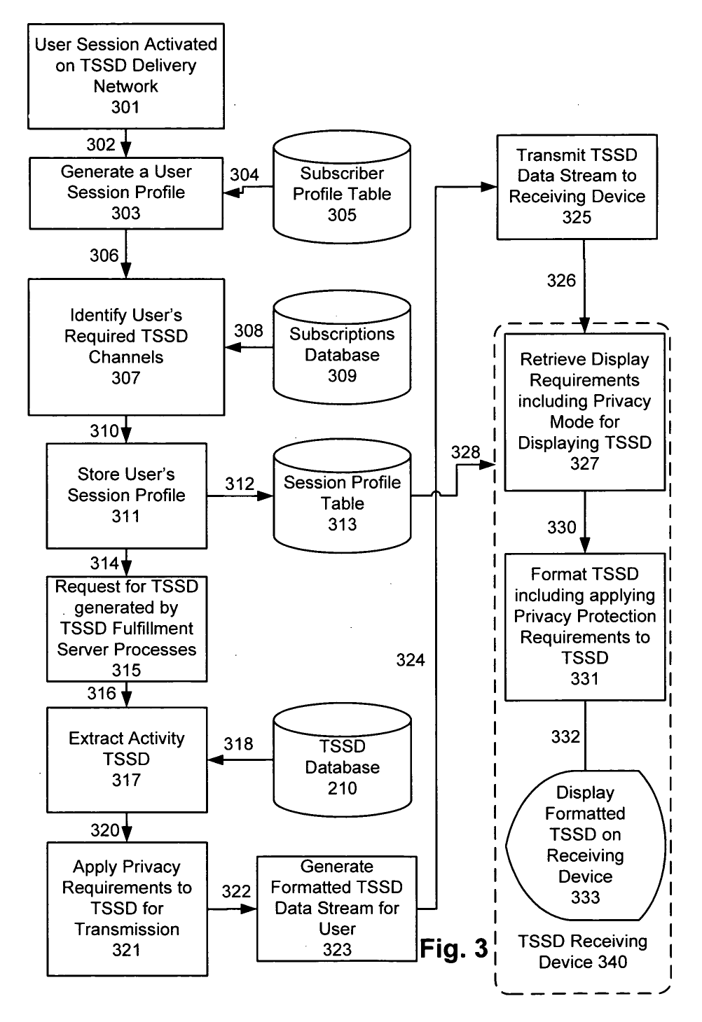

FIG. 3 is a flowchart of a TSSD activity content fulfillment process showing the locations of the Privacy Protection Functions, according to one embodiment of the invention. The process begins with a user session being activated on the TSSD Delivery Network at block 301. User and receiving device identification is transmitted on line 302 to a function which generates a user session profile at block 303, at which point the user's subscriber profile, including privacy display mode preferences, is extracted from the Subscriber Profile Table 305 and received over line 304.

The user and receiving device identification data and privacy display mode preferences may then be transmitted on line 306 to the Identify User's Required TSSD Channel Function 307. The Identify User's Required TSSD Channels Function 307 extracts the user's TSSD channel subscriptions identifiers from the Subscriptions Database 309 (which it receives on line 308) and transmits on line 310 the user and receiving device identification data, the user's privacy display mode preferences and the user's identifiers for the authorized and active TSSD channel subscriptions to the Store User's Session Profile Function 311. The Store User's Session Profile Function 311 stores on line 312 the user session profile which may include the user and receiving device identification data, the user's privacy display mode preferences, the user's TSSD channel subscriptions, and administrative parameters such a session profile identifier, starting time, and network use limitations to the Session Profile Table 313.

Once the session profile has been successfully stored, the Store User's Session Profile Function 311 triggers a status on line 314 which causes a request for a TSSD data stream to be generated by the TSSD Fulfillment Server Processes 315. The request generated by these processes may include data range, time frame, selection TSSD category, and user TSSD subscriptions. The request for TSSD to be generated by the TSSD Fulfillment Server Processes 315 transmits on line 316 to the Extract Activity TSSD Function 317 a request for relevant TSSD to be delivered to the user's receiving device, the user and receiving device identification data, the user's privacy display mode preferences, the user's TSSD channel subscriptions, and administrative parameters such a session profile identifier, starting time, and network use limitations, The Extract Activity TSSD Function 317 extracts the targeted TSSD, if any, on line 318 from the TSSD Database 210 and transmits on line 320 the TSSD along with the user and receiving device identification data and the user's privacy display mode preferences.

The Apply Privacy Requirements to TSSD for Transmission Function 321 receives this transmission and reformats the activity TSSD for transmission if required by the user's privacy preference or business privacy policies which may apply to the type or source of the activity TSSD. The Apply Privacy Requirements to TSSD for Transmission Function 321 may then transmit the results on line 322 to the Generate Formatted TSSD Data Stream for User Function 323 where all of the extracted and formatted TSSD plus identifications information may be consolidated into a TSSD data stream targeted at the user's receiving device.

Continuing to refer to FIG. 3, the Generate Formatted TSSD Data Stream for User Function 323 may transmit on line 324 the TSSD data stream to the Transmit TSSD Data Stream to Receiving Device Function 325. The Transmit TSSD Data Stream to Receiving Device Function 325 transmits the TSSD data stream on line 326 through the Communications Cloud to a set of display processes which reside on the user TSSD Receiving Device 340. The Retrieve Display Requirements including Privacy Mode for Displaying TSSD Function 327 receives the TSSD data stream and if there is activity TSSD, extracts on line 328 from the Session Profile Table 313 privacy mode display requirements for the activity TSSD. The Retrieve Display Requirements including Privacy Mode for Displaying TSSD Function 327 transmits on line 330 to the Format TSSD including applying Privacy Protection Requirements to TSSD for Display Function 331 the TSSD data stream and privacy protection requirements if any. In one embodiment, the Format TSSD including applying Privacy Protection Requirements to TSSD for Display Function 331 may parse the TSSD data stream, format each TSSD activity as required, and transmit the results on line 332 to the receiving devices display function. The Display Formatted TSSD on Receiving Device Function 333 may then display the privacy protected activity TSSD on the receiving devices display unit for the user's consumption.

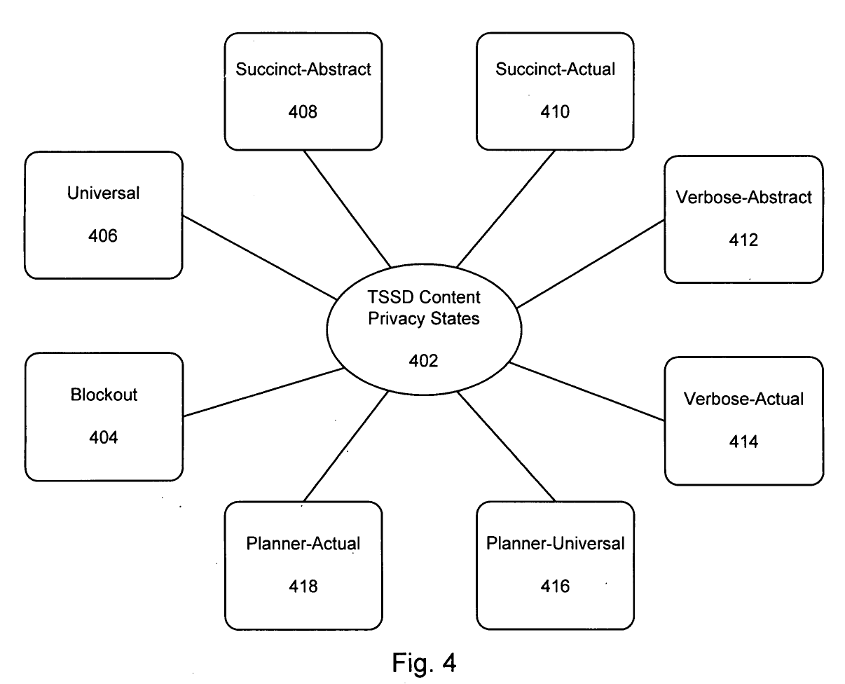

FIG. 4 is a class diagram displaying TSSD Content Privacy States 402 which may impact a TSSD Delivery Network's transmission of or display of TSSD content according to one embodiment of the invention. The TSSD Content Privacy States 402 from the highest to lowest level are: blockout 404, universal 406, succinct-abstract 408, succinct-actual 410, verbose-abstract 412, verbose-actual 414, planner-universal 416 and planner-actual 418.

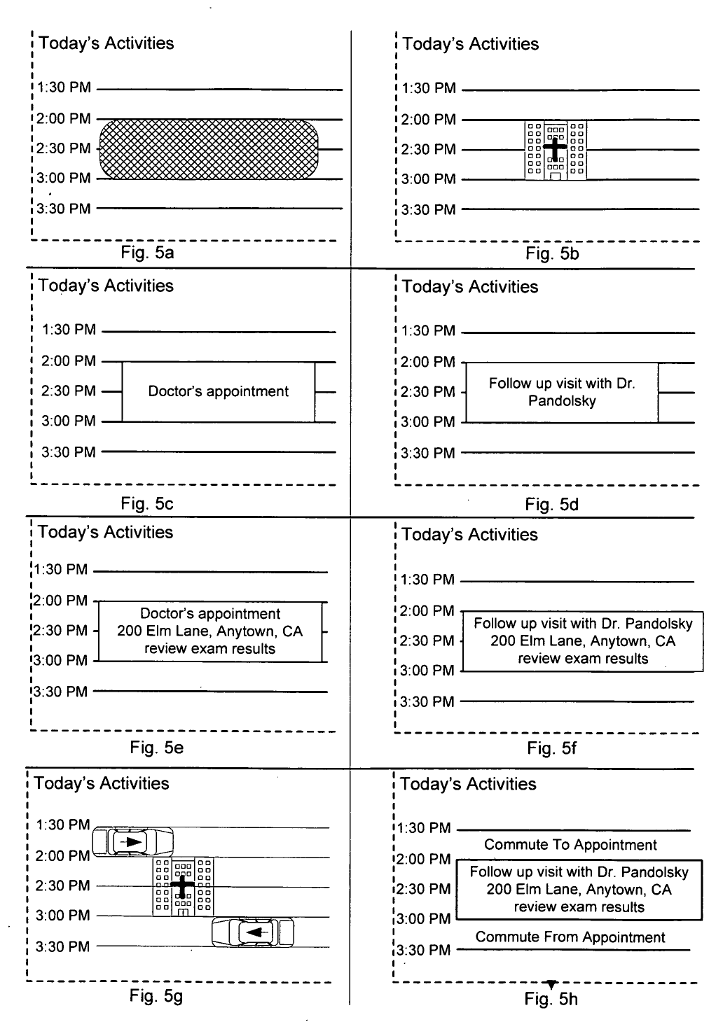

FIGS. 5a-5h show examples of what a single TSSD activity would appear as in the various content privacy states of FIG. 4, in accordance with one embodiment of the invention.

In one embodiment of the invention, when the content privacy state is set to blockout or an equivalent thereof (i.e., blockout 404 of FIG. 4), the display function enters blockout mode and may displays a blockout icon representing an unidentified activity, a color coded cell or a cell with a pattern inside across the time period that the TSSD activity covers. FIG. 5a is a representative screen shot of such a display. In one embodiment, when the content privacy state is set to blockout 404, the transmission function may enter a blockout mode and transmit the activity's starting date, starting time and a token (a code) to tell the display function to display this TSSD activity using blockout mode.

In one embodiment of the invention, when the content privacy state is set to universal or an equivalent thereof (i.e., universal 406 of FIG. 4), the display function may enter a universal mode and displays an icon representing the type of activity that the TSSD activity is. FIG. 5b is a representative screen shot of such a display. In one embodiment, when the content privacy state is set to universal 406, the transmission function enters universal mode and may transmit the activity's starting date, starting time, an icon representing the type of activity and a status code to tell the display function to display this TSSD activity using universal mode.

In one embodiment of the invention, when the content privacy state is set to succinct-abstract or an equivalent thereof (i.e., succinct-abstract 408), the display function enters succinct-abstract mode and may displays a word or phrase representing the type of activity that the TSSD activity is. FIG. 5c is a representative screen shot of such a display. In one embodiment, when the content privacy state is set to succinct-abstract 408, the transmission function enters succinct-abstract mode and may transmit the activity's starting date, starting time, a word or phrase representing the type of activity and a status code to tell the display function to display this TSSD activity using succinct-abstract mode.

In one embodiment of the invention, when the content privacy state is set to succinct-actual or an equivalent thereof (i.e., succinct-actual 410), the display function enters succinct-actual mode and may display the actual activity name as specified by the originators of the activity or the entity posting the activity to the TSSD Delivery Network. FIG. 5d is a representative screen shot of such a display. In one embodiment, when the content privacy state is succinct-actual 410, the transmission function enters succinct-actual mode and may transmit the activity's starting date, starting time, actual activity name as specified by the originators of the activity or the entity posting the activity to the TSSD Delivery Network, and a status code to tell the display function to display this TSSD activity using succinct-actual mode.

In one embodiment of the invention, when the content privacy state is set to verbose-abstract or an equivalent thereof (i.e., verbose-abstract 412), the display function enters verbose-abstract mode and may displays a word or phrase representing the type of activity that the TSSD activity is and a brief description of the activity as provided by the originators of the activity or the entity posting the activity to the TSSD Delivery Network. FIG. 5e is a representative screen shot of such a display. In one embodiment, when the content privacy state is verbose-abstract 412 the transmission function enters verbose-abstract mode and may transmit the activity's starting and ending date, starting and ending time, a word or phrase representing the type of activity, a brief description of the activity as provided by the originators of the activity or the entity posting the activity to the TSSD Delivery Network, and a status code to tell the display function to display this TSSD activity using verbose-abstract mode.

In one embodiment of the invention, when the content privacy state is set to verbose-actual or an equivalent thereof (i.e., verbose-actual 414), the display function enters verbose-actual mode and may display the actual activity name and a brief description of the activity as specified by the originators of the activity or the entity posting the activity to the TSSD Delivery Network. FIG. 5f is a representative screen shot of such a display. In one embodiment, when the content privacy state is verbose-actual 414, the transmission function enters verbose-actual mode and may transmit the activity's starting and ending date, starting and ending time, actual activity name and a brief description of the activity as specified by the originators of the activity or the entity posting the activity to the TSSD Delivery Network, and a status code to tell the display function to display this TSSD activity using verbose-actual mode.

In one embodiment of the invention, when the content privacy state is set to planner-universal or an equivalent thereof (i.e., planner-universal 416), the display function enters planner-universal mode and may display an icon representing the type of activity that the TSSD activity is, plus icon representing related and complementary activities which would normally occur within in the specific chronological time frame when the triggering TSSD activity would take place. For example, a doctor's appointment would usually involve a commute to the doctor's office. So in planner-universal mode, commute to and commute from activities may appear on the display along with the doctor's appointment. FIG. 5g is a representative screen shot of such a display. In one embodiment, when the content privacy state is planner-universal 416, the transmission function enters planner-universal mode and may transmit the activity's starting and ending date, starting and ending time, an icon representing the type of activity that the TSSD activity is, icons for related and complementary activities and a status code to tell the display function to display this TSSD activity using planner-universal mode.

In one embodiment of the invention, when the content privacy state is set to planner-actual or an equivalent thereof (i.e., planner-actual 418), the display function enters planner-actual mode and may display the actual activity name and a brief description of the activity as specified by the originators of the activity or the entity posting the activity to the TSSD Delivery Network, plus a group of related and complementary activities which would normally occur within in the specific chronological time frame when the triggering TSSD activity would take place. For example, a doctor's appointment would usually involve a commute to the doctor's office. So in planner-actual mode, commute to and commute from activities may appear on the display along with the doctor's appointment. FIG. 5h is a representative screen shot of such a display. In one embodiment, when the content privacy state is planner-actual 418, the transmission function enters planner-actual mode and may transmit the activity's starting and ending date, starting and ending time, actual activity name and a brief description of the activity as specified by the originators of the activity or the entity posting the activity to the TSSD Delivery Network, related and complementary activities and a status code to tell the display function to display this TSSD activity using planner-actual mode.

The TSSD Content Privacy States 402 for transmission of TSSD or displaying or playing TSSD is determined by the subscriber's preference and this preference is preserved in the subscriber's profile. In an embodiment of the TSSD privacy method the TSSD Delivery Network may have automatically applied content privacy states to the transmission or display of certain classes of TSSD activities. For example, medical appointments may be transmitted at a higher level of privacy when the TSSD fulfillment processes recognize that the activity is being displayed on a public device.

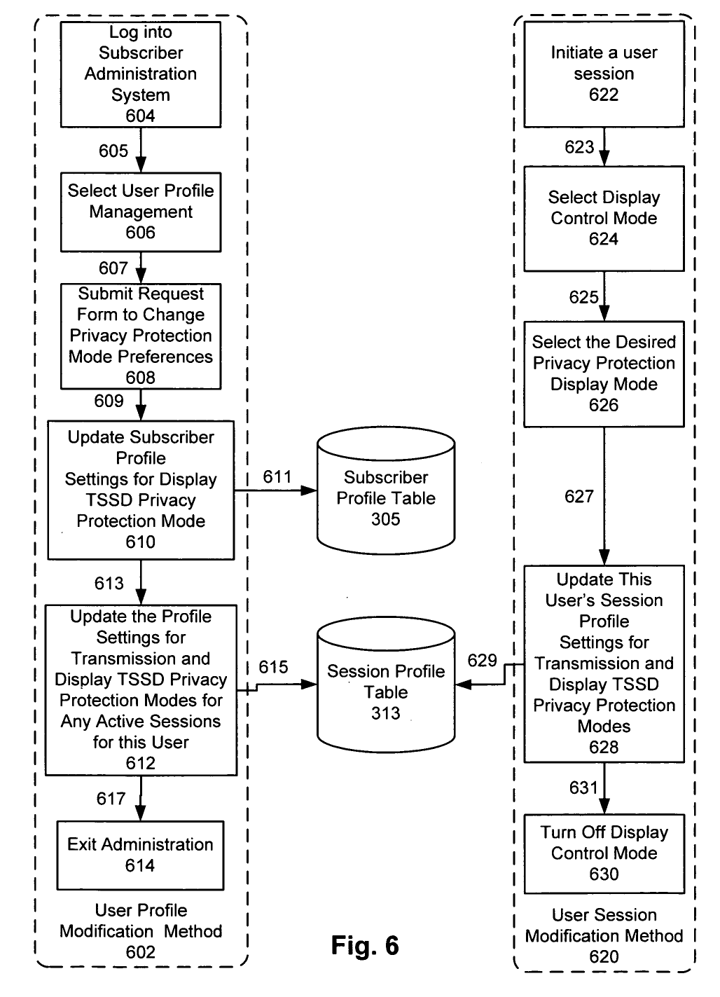

FIG. 6 is a flowchart showing two methods a user may use to specify a desired level of privacy protection for displaying TSSD according to one embodiment of the invention. The User Profile Modification Method 602 allows the user to set a privacy protection level that remains in effect until the setting is modified by the user, i.e., the privacy protection mode all future session until changed by the user. The User Session Modification Method 620 allows the user to set a privacy protection mode which effects only this user session and remains in effect until the current user session ends, until the user makes another session medication or until the Privacy Protection Mode Setting is modified by the User Profile Modification Method 602.

Using the User Profile Modification Method 602 to set the Privacy Protection Mode Setting, the user logs into the Subscriber Administration System 604. Next, the user on line 605 may select the User Profile Management Function 606. Within this function, the user on line 607 may then submit a Request Form to Change Privacy Protection Mode Preferences 608. The privacy protection mode selection may then be transmitted on line 609 to the Update Subscriber Profile Settings for Display TSSD Privacy Protection Mode Function 610. The Update Subscriber Profile Settings for Display TSSD Privacy Protection Mode Function 610 on line 611 updates the user's subscriber profile in the Subscriber Profile Table 305, and forwards the privacy protection mode selection on line 613 to a function which updates any active session profiles for this user. The Update the Profile Settings for Transmission and Display TSSD Privacy Protection Modes for Any Active Sessions of this User Function 612 updates active session profiles on line 615 in Session Profile Table 313. The user may end this method by Exiting the Administrative Function 614 via line 617.

Using the User Session Modification Method 620 to set the Privacy Protection Mode Setting for the current user session, the user Initiates a User Session at 622. Next the user selects to transition to the Display Control Mode Function 624 on line 623 and selects to transition to the Select the Desired Privacy Protection Display Mode Function 626 on line 625. The Select the Desired Privacy Protection Display Mode Function 626 presents a set of privacy protection display mode options to the user and forwards the user's selection on line 627 to a function which updates the user's session profile. The Update This User's Session Profile Settings for Transmission and Display TSSD Privacy Protection Modes Function 628 on line 629 updates the user's session profile in the Session Profile Table 313. The user on line 631 ends this method by Turning off Display Control Mode 630.

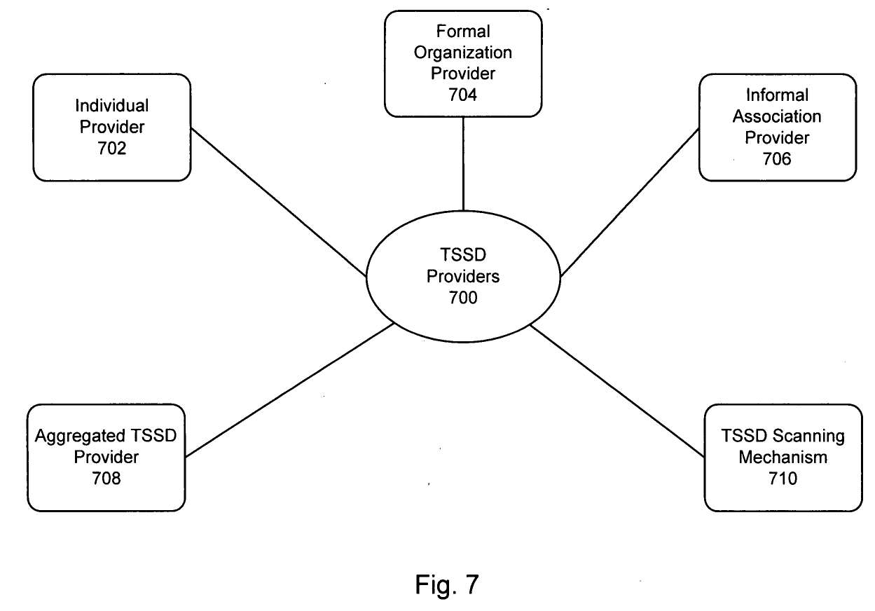

FIG. 7 is a class diagram illustrating providers of the specific TSSD according to an embodiment of the invention. In the class diagram are described the TSSD providers 700. TSSD providers 700 may be the originating entities for the event or activity or they may be merely submitting TSSD attributes of events, meeting, activities, and observances (see e.g., FIG. 9).

The individual provider 702 of FIG. 7 may be any person acting in their own interest who provides TSSD related to their own activities to the TSSD privacy protection method.

A formal organization provider 704 may be an organization which is certified by any authority generally recognized as a governing body and which has a formalized membership and leadership structure that provides TSSD based on its own activities or group interests to the TSSD privacy protection method. Examples of formal organization providers 704 may include companies with staff, trade associations like the American Bar Association, little league sports teams, and fan clubs.

An informal association provider 706 may be an informal group of individuals or groups which have a loose membership and leadership structure and simple affiliation mechanism. An informal association provider 706 may also be a group of individuals that share common characteristics or derived interests but are loosely or not formally organized. An informal association provider 706 can provide TSSD based on its own activities or group interests to the TSSD privacy protection method. Examples of informal association provider 706 groups may include pickup sports teams, adult league sports teams, internet social networks, groups of school friends, and ad-hoc parents groups at schools.

An aggregated TSSD provider 708 may be an entity that submits TSSD to the TSSD privacy protection method in bulk or aggregated form. An aggregated TSSD provider 708 can submit TSSD which may be generally not the result of their own activities, but may be a collection of activities originated by other organizations that the aggregated TSSD provider 708 can publish for the benefit of others. Examples of aggregated TSSD providers 708 may include chambers of commerce and media publication companies such as newspaper, magazine, and radio/TV broadcasters.

Finally, a TSSD scanning mechanism 710 may be a mechanism which harvests TSSD by searching data posted on the internet or published in print and radio/TV media. The scanning mechanism may be automated as with software tools which can search internet websites or manual labor who scan published media. Examples of TSSD scanning mechanism 710 are search-engine targeted at TSSD data and call centers targeting entertainment venues for information about upcoming events.

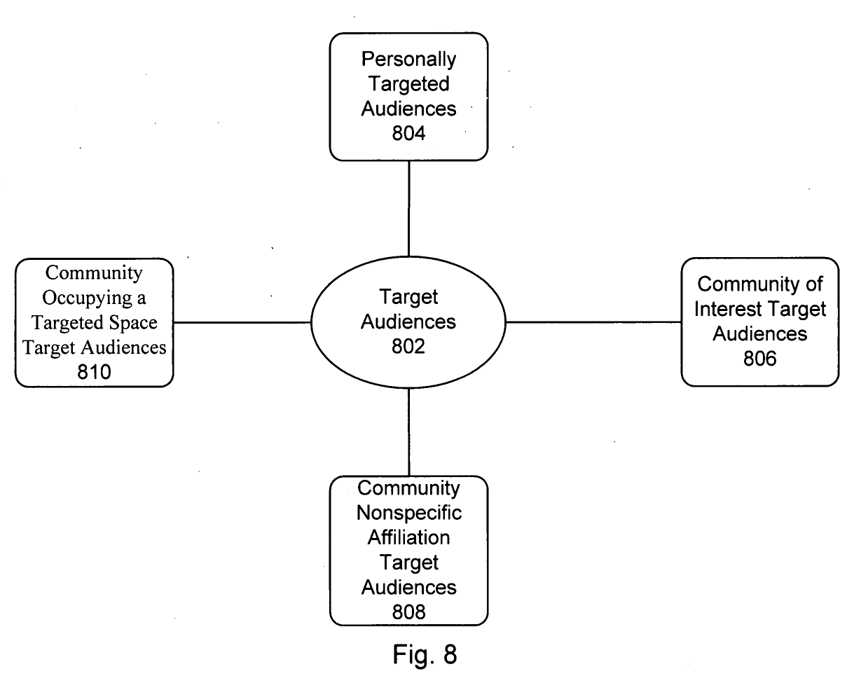

FIG. 8 is a class diagram illustrating the target audiences according to an embodiment of the invention. In the FIG. 8 class diagram are displayed the primary audience classes of Target Audiences 802.

In one embodiment, Personally Targeted Audiences 804 may be individuals to whom specific TSSD and promotional material are streamed based on the attributes and preferences explicit in their personal profile in the TSSD privacy protection method. Personally Targeted Audiences 804 may include audiences targeted by self-chosen membership or direct affiliation with a TSSD privacy protection method product client. Examples of Personally Targeted Audiences 804 may include active members of a service or social club, lapsed members of a trade association, board members of a not-for-profit organization, board members, staff or clients of a business, and individual subscribers to the TSSD privacy protection method services.

Community of Interest Target Audiences 806 may correspond to audiences who share identified common affiliations deemed significant for this invention and to whom specific TSSD and promotion materials are streamed based on their affiliations, the common attributes derived for the community group, and the specific preferences of significant members of the community group. Community of Interest Target Audiences 806 may include dentist, alumni of a college, fans of an artist or genre of music, and wine lovers who prefer cabernet sauvignon.

In one embodiment, Community Nonspecific Affiliation Target Audiences 808 may be audiences who share identified common attributes deemed significant for this invention and to whom specific TSSD and promotion materials are streamed based on the common attributes and affiliations derived for the community group, and the specific preferences of significant members of the community group. Community Nonspecific Affiliation Target Audiences 808 may include adults age 26-35 or people who attended a conference on space exploration last year.

Community Occupying a Targeted Space Target Audiences 810 may be audiences who share a common space (physical or virtual) at a targeted time deemed significant for this invention and to whom specific TSSD and promotion materials are streamed based on the occupancy of that space at that time. Community Occupying a Targeted Space Target Audiences 810 sharing a physical space may include sports, concert, performing arts event attendees, attendees of conferences and conventions, attendees at public festivals such as art and wine festivals or food festivals, attendees at political rallies and attendees at private events such as weddings, roasts, church services and/or observances. Community Occupying a Targeted Space Target Audiences 810 sharing a confined space may also include passengers on a bus, boat, plane or train. Community Occupying a Targeted Space Target Audiences 810 sharing a virtual space may include all internet users browsing a particular organization's website, all phone users participating in a conference call, and all attendees to a virtual web conference.

FIG. 9 is an objects diagram illustrating basic attributes of TSSD 900 according to an embodiment of the invention. In the objects diagram may be defined sets of TSSD Attributes 900. These TSSD Attributes 900 include: Type 902; Start Time/End Time 904; Start Date/End Date 906; Name 908; Source/Owner 910; Target Audience 912; Display Parameters 914 which may include graphics, logos, captions, and colors; Visibility Parameters 916 (e.g., posting date, hide flag); Administration Parameters 918 (e.g., who created, when created); Description of Activity 920; Host of Activity 922; and Location 924.

The invention is preferably implemented by software, but can also be implemented in hardware or combination of hardware and software. The invention can also be embodied as computer readable code on a computer readable medium. The computer readable medium is any data storage device that can store data which can thereafter be read by a computer system. Examples of the compute readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The drawings and the foregoing description gave examples of the present invention providing a time sensitive scheduling data privacy protection method and related aspects. Although depicted as a number of disparate functional items, those skilled in the art will appreciate that one or more of such elements may well be combined into single functional entities. Alternatively, certain elements may be split into multiple functional elements. The scope of the present invention, however, is by no means limited by these specific examples. Numerous variations, whether explicitly given in the specification or not, such as differences in structure, dimension, and use of material, are possible. Although the present invention has been described in considerable detail with reference to certain embodiments thereof, the invention may be variously embodied without departing from the spirit or scope of the invention. Therefore, the following claims should not be limited to the description of the embodiments contained herein in any way.

What is claimed is:

1. A method for providing privacy protection to an entity related to the passive delivery of time sensitive scheduling data via a Time Sensitive Scheduling Data Delivery Network, the method comprising:
accommodating a communications network based passive delivery of privacy protected time sensitive scheduling data to an entity;
aggregating into time sensitive scheduling data streams, specific privacy protected time sensitive scheduling data from sources including originating organizations, affiliated groups of individuals, and individuals;
transmitting via the communications network specific privacy protected time sensitive scheduling data streams aggregated from sources including multiple originating organizations, affiliated groups of individuals, and individuals to the entity; and
presenting time sensitive scheduling data in a manner affording privacy based on content privacy states which determine representation of a time sensitive scheduling data item being presented.

2. The method of claim 1, further comprising:
transforming time sensitive scheduling data in a manner affording privacy based on the content privacy states which determine the representation of a time sensitive scheduling data item being transmitted and presented.

3. The method of claim 2, wherein transforming comprises exposing a range of time sensitive scheduling data attributes from related attributes of identification, scheduling and location to a start date, start time and a generic icon representing a type of activity, and wherein the ranges of time sensitive scheduling data attributes exposure represent content privacy states.

4. The method of claim 2, wherein transforming occurs within a programming function at the sourcing data center for transmission and on capable time sensitive scheduling data receiving devices for presentation.

5. The method of claim 2, further comprising:
establishing the content privacy state for transmission and presentation of time sensitive scheduling data according to an area of interest of the entity and reception zone for the data.

6. The method of claim 2, further comprising:
establishing the content privacy state for transmission and presentation of time sensitive scheduling data according to affiliation between a providing entity and receiving entity.

7. The method of claim 2, further comprising:
establishing the content privacy state for transmission and presentation of reminder time sensitive scheduling data according to an entity's presentation content privacy state preference for time sensitive scheduling data, a closeness to start time for a time sensitive scheduling data activity which is the subject of the reminder time sensitive scheduling data, and a device receiving the reminder time sensitive scheduling data.

8. The method of claim 7, wherein the reminder time sensitive scheduling data comprises time sensitive scheduling data items is selected from the group consisting of receiving entity designated reminder items, receiving entity tagged reminder item, time sensitive scheduling data delivery network treated major life event items, and a combination thereof.

9. The method of claim 2, further comprising:
establishing the content privacy state for transmission and presentation of reservation time sensitive scheduling data according to an entity's presentation content privacy state preference for time sensitive scheduling data, a closeness to start time for a time sensitive scheduling data activity which is the subject of the reservation time sensitive scheduling data, and a device receiving the reservation time sensitive scheduling data.

10. The method of claim 2, wherein the privacy afforded is based on the representation of a time sensitive scheduling data item within a communication transmitted from a data center source data store to a receiving device.

11. The method of claim 2, wherein the representation of the time sensitive scheduling data item transmitted ranges from sending identification and scheduling details of the item from item attributes comprising name, start and end date, start and end time, location and activity description to sending an encoded string of characters which when decoded by a receiving device reproduces item attributes and representation of item attributes from a group of item attributes comprising name, start date, start time, and location.

12. The method of claim 1, the representation of the time sensitive scheduling data item ranges from presenting identification and scheduling details of the item from item attributes comprising name, start and end date, start and end time, location and activity description to presenting a blocked out area indicating start time and end time of an unidentified time sensitive data item.

13. The method of claim 1, further comprising:
protecting the privacy of a time sensitive scheduling data delivery network user by providing a designated and desired level of privacy in accordance with a time sensitive scheduling data receiving device's profile and assigned privacy preference.

14. A system for providing privacy protection to an entity related to the passive delivery of time sensitive scheduling data via a Time Sensitive Scheduling Data Delivery Network, the system comprising:
a time sensitive scheduling data center for storing privacy protected time sensitive scheduling data, collecting privacy protected time sensitive scheduling data from an entity, and sending privacy protected time sensitive scheduling data to the entity;
connectivity medium communication interfaces for transmitting privacy protected time sensitive scheduling data between the time sensitive scheduling data center, a communication technology, and a time sensitive scheduling data receiving device;
a communication technology suitable for receiving and sending the passive delivery of privacy protected time sensitive scheduling data;
processors for processing executable instructions for:
accommodating a communications network based passive delivery of privacy protected time sensitive scheduling data to an entity;
aggregating into time sensitive scheduling data streams, specific privacy protected time sensitive scheduling data from sources including originating organizations, affiliated groups of individuals, and individuals;
transmitting via the communications network specific privacy protected time sensitive scheduling data streams aggregated from sources including multiple originating organizations, affiliated groups of individuals, and individuals to the entity;
presenting time sensitive scheduling data in a manner affording privacy based on content privacy states which determine representation of a time sensitive scheduling data item being presented; and
a time sensitive scheduling data receiving device for receiving and sending protected privacy time sensitive scheduling data to the time sensitive scheduling data center via the connectivity medium communication interfaces via the communication technology.

15. The system of claim 14, further comprising:
transforming time sensitive scheduling data in a manner affording privacy based on the content privacy states which determine the representation of a time sensitive scheduling data item being transmitted and presented.

16. The system of claim 15, wherein transforming comprises exposing a range of time sensitive scheduling data attributes from related attributes of identification, scheduling and location to a start date, start time and a generic icon representing a type of activity, and wherein the ranges of time sensitive scheduling data attributes exposure represent content privacy states.

17. The method of claim 15, wherein transforming occurs within a programming function at the sourcing data center for transmission and on capable time sensitive scheduling data receiving devices for presentation.

18. The system of claim 15, further comprising:
establishing the content privacy state for transmission and presentation of time sensitive scheduling data according to an area of interest of the entity and reception zone for the data.

19. The system of claim 15, further comprising:
establishing the content privacy state for transmission and presentation of time sensitive scheduling data according to affiliation between a providing entity and receiving entity.

20. The system of claim 15, further comprising:
establishing the content privacy state for transmission and presentation of reminder time sensitive scheduling data according to an entity's presentation content privacy state preference for time sensitive scheduling data, a closeness to start time for a time sensitive scheduling data activity which is the subject of the reminder time sensitive scheduling data, and a device receiving the reminder time sensitive scheduling data.

21. The system of claim 20, wherein the reminder time sensitive scheduling data comprises time sensitive scheduling data items is selected from the group consisting of receiving entity designated reminder items, receiving entity tagged reminder item, time sensitive scheduling data delivery network treated major life event items, and a combination thereof.

22. The system of claim 15, further comprising:
establishing the content privacy state for transmission and presentation of reservation time sensitive scheduling data according to an entity's presentation content privacy state preference for time sensitive scheduling data, a closeness to start time for a time sensitive scheduling data activity which is the subject of the reservation time sensitive scheduling data, and a device receiving the reservation time sensitive scheduling data.

23. The system of claim 15, wherein the privacy afforded is based on the representation of a time sensitive scheduling data item within a communication transmitted from a data center source data store to a receiving device.

24. The system of claim 15, wherein the representation of the time sensitive scheduling data item transmitted ranges from sending identification and scheduling details of the item from item attributes comprising name, start and end date, start and end time, location and activity description to sending an encoded string of characters which when decoded by a receiving device reproduces item attributes and representation of item attributes from a group of item attributes comprising name, start date, start time, and location.

25. The system of claim 14, the representation of the time sensitive scheduling data item ranges from presenting identification and scheduling details of the item from item attributes comprising name, start and end date, start and end time, location and activity description to presenting a blocked out area indicating start time and end time of an unidentified time sensitive data item.

26. The system of claim 14, further comprising:
protecting the privacy of a time sensitive scheduling data delivery network user by providing a designated and desired level of privacy in accordance with a time sensitive scheduling data receiving device's profile and assigned privacy preference.

27. A computer program product executable by a computer processor for processing the providing privacy protection to an entity related to the passive delivery of time sensitive scheduling data via a Time Sensitive Scheduling Data Delivery Network, comprising:
computer code for accommodating a communications network based passive delivery of privacy protected time sensitive scheduling data to an entity;
computer code for aggregating into time sensitive scheduling data streams, specific privacy protected time sensitive scheduling data from originating organizations, affiliated groups of individuals, and individual sources;
computer code for transmitting via the communications network specific privacy protected time sensitive scheduling data streams aggregated from multiple originating organizations, affiliated groups of individuals, and individual sources to the entity;
computer code for presenting time sensitive scheduling data in a manner affording privacy based on content privacy states which determine the representation of a time sensitive scheduling data item being presented; and
computer readable medium for storing the computer code.

28. The computer program product of claim 27, further comprising:
transforming time sensitive scheduling data in a manner affording privacy based on the content privacy states which determine the representation of a time sensitive scheduling data item being transmitted and presented.

29. The computer program product of claim 28, wherein transforming comprises exposing a range of time sensitive scheduling data attributes from related attributes of identification, scheduling and location to a start date, start time and a generic icon representing a type of activity, and wherein the ranges of time sensitive scheduling data attributes exposure represent content privacy states.

30. The computer program product of claim 28, wherein transforming occurs within a programming function at the sourcing data center for transmission and on capable time sensitive scheduling data receiving devices for presentation.

31. The computer program product of claim 28 further comprising:
establishing the content privacy state for transmission and presentation of time sensitive scheduling data according to an area of interest of the entity and reception zone for the data.

32. The computer program product of claim 28, further comprising:
establishing the content privacy state for transmission and presentation of time sensitive scheduling data according to affiliation between a providing entity and receiving entity.

33. The computer program product of claim 28, further comprising:
establishing the content privacy state for transmission and presentation of reminder time sensitive scheduling data according to an entity's presentation content privacy state preference for time sensitive scheduling data, a closeness to start time for a time sensitive scheduling data activity which is the subject of the reminder time sensitive scheduling data, and a device receiving the reminder time sensitive scheduling data.

34. The computer program product of claim 33, wherein the reminder time sensitive scheduling data comprises time sensitive scheduling data items is selected from the group consisting of receiving entity designated reminder items, receiving entity tagged reminder item, time sensitive scheduling data delivery network treated major life event items, and a combination thereof.

35. The computer program product of claim 28, further comprising:
establishing the content privacy state for transmission and presentation of reservation time sensitive scheduling data according to an entity's presentation content privacy state preference for time sensitive scheduling data, a closeness to start time for a time sensitive scheduling data activity which is the subject of the reservation time sensitive scheduling data, and a device receiving the reservation time sensitive scheduling data.

36. The computer program product of claim 28 wherein the privacy afforded is based on the representation of a time sensitive scheduling data item within a communication transmitted from a data center source data store to a receiving device.

37. The computer program product of claim 28 wherein the representation of the time sensitive scheduling data item transmitted ranges from sending identification and scheduling details of the item from item attributes comprising name, start and end date, start and end time, location and activity description to sending an encoded string of characters which when decoded by a receiving device reproduces item attributes and representation of item attributes from a group of item attributes comprising name, start date, start time, and location.

38. The computer program product of claim 27, the representation of the time sensitive scheduling data item ranges from presenting identification and scheduling details of the item from item attributes comprising name, start and end date, start and end time, location and activity description to presenting a blocked out area indicating start time and end time of an unidentified time sensitive data item.

39. The computer program product of claim 27, further comprising:
protecting the privacy of a time sensitive scheduling data delivery network user by providing a designated and desired level of privacy in accordance with a time sensitive scheduling data receiving device's profile and assigned privacy preference.
